(19) United States
(12) Patent Application Publication
(10) Pub. No.: US 2020/0126067 A1
(43) Pub. Date: Apr. 23, 2020

(54) Process Flow Management

(71) Applicant: AEVI International GmbH, Paderborn (DE)

(72) Inventors: Edward George Johnson, London (GB); Brett Antony John Cherrington, Dorset (GB)

(21) Appl. No.: 16/659,502

(22) Filed: Oct. 21, 2019

Related U.S. Application Data
(60) Provisional application No. 62/748,010, filed on Oct. 19, 2018.

(51) Int. Cl. G06Q 20/34; G06Q 20/32

(52) U.S. Cl. CPC G06Q 20/34; G06Q 20/3278

(57) ABSTRACT

A process flow management solution that is designed to facilitate standardized integration between applications in a point of sale environment in order to manage the ‘checkout’ experience. This is made possible via APIs that allows applications to initiate flows and for other applications to be called at any point in those flows to read and augment relevant data.

### CROSS REFERENCE TO RELATED APPLICATIONS

This application claims the benefit under 35 U.S.C. § 119 of U.S. Provisional Application No. 62/748,010, filed Oct. 19, 2018. The contents of the aforementioned application/s is/are hereby incorporated by reference herein in its/their entirety.

### TECHNICAL FIELD

The present disclosure relates generally to managing process flows, such as point of sale (“POS”) process flows.

### BACKGROUND

Process flows typically involve a central application that calls applications in a configured sequence. The applications need to integrate with the central application directly. Applications not integrated with the central application cannot be used. Except for with the central application, the applications cannot exchange data with each other.

### SUMMARY OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein a methodology for processing a payment using a flow processing service. The flow processing service employs predefined application programming interfaces to specify stages of the flow and applications to be executed at each stage.

In accordance with an example embodiment, there is disclosed herein a methodology for processing flows using a flow processing service. The flow processing service employs predefined application programming interfaces to specify stages of the flow and applications to be executed at each stage.

In accordance with an example embodiment there is disclosed herein, a methodology for creating value added applications for a flow that uses a flow processing service. Using the application programming interfaces, stages for the flow can be specified, and for each stage a type of flow can be specified that determines how value added programs will be handled by that stage.

### BRIEF DESCRIPTION OF THE DRAWINGS

The accompanying drawings incorporated herein and forming a part of the specification illustrate the example embodiments.

FIG. 1 is a block diagram of illustrating an example of a system that employs a process flow management in accordance with an example embodiment.

FIG. 2 is a block diagram illustrating an example of an application flow that employs a flow processing service in accordance with an example embodiment.

FIG. 3 is a block diagram illustrating an example of the stages a Point of Sale (“POS”) system can employ.

FIG. 4 is a more detailed block diagram illustrating an example of a Point of Sale (“POS”) flow that employs a flow processing service for processing stages of a flow.

FIG. 5 is a block diagram that illustrates a computer system 500 upon which an example embodiment may be implemented.

FIG. 6 is a block diagram illustrating an example of a methodology implemented by the flow processing service described herein.

FIG. 7 is a block diagram illustrating an example of a methodology 700 for a developer to implement a Value Added Application (VAA) for use with the flow processing service described herein.

FIG. 8 is a block diagram illustrating an example of a methodology for a payment processing flow implemented by the flow processing service described herein.

FIG. 9 is a block diagram illustrating an example of a methodology for processing a payment for a coffee shop.

FIG. 10 is a block diagram illustrating an example of a methodology for implementing a payment process flow for a car rental.

FIG. 11 is a block diagram illustrating an example of a methodology for implementing a payment process flow for a restaurant.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

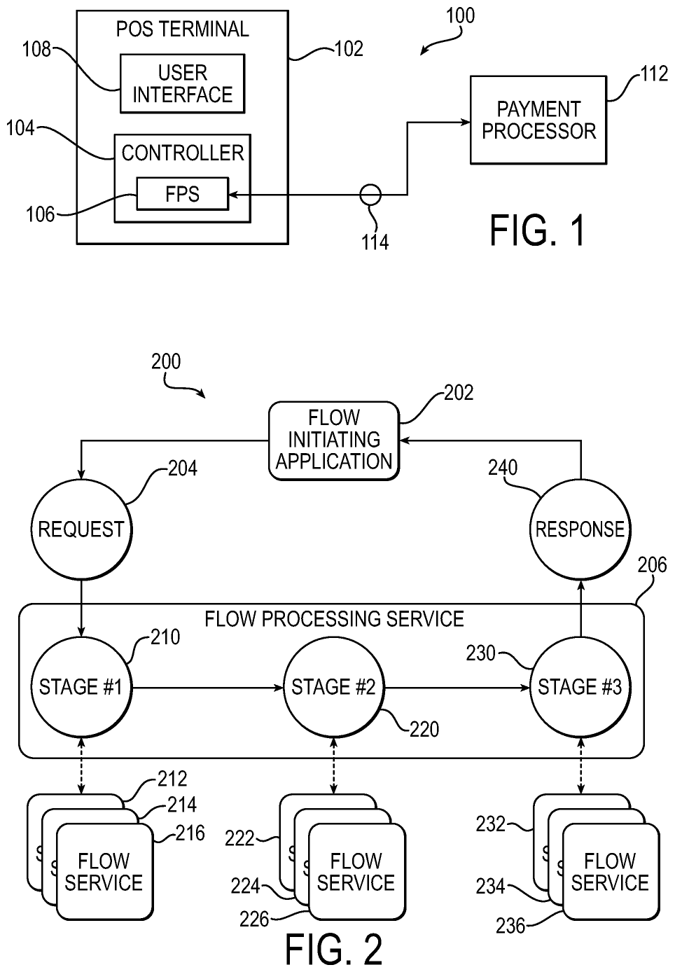

FIG. 1 illustrates an example of a system 100 that employs process flow management in accordance with an example embodiment. The illustrated example is for a payment process for a point of sale transaction.

In the illustrated example, a point of sale (“POS”) terminal 102 comprises a controller 104 that employs an example of a flow processing service (“FPS”) 106 configured in accordance with an example embodiment, and a user interface 108. The controller comprises logic for implementing the functionality of the POS terminal 102 and the FPS 106. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software that performs the desired functionality when executed by a processor.

The user interface 108 is employed to obtain data for conducting the transaction. For example, the user interface 108 can obtain data representative of the purchase (e.g., items purchased and/or amount), data representative of the purchaser (user), data representative of the payment method (cash, check, card, split) and where appropriate card or account data from the purchaser. For example, the user interfaced 108 may comprise one or more of a card reader, keypad or touch screen, wireless reader such as a Near Field Communication (NFC) interface or other suitable wireless interface. The user interface 108 may also be employed to provide outputs to the purchaser. For example, the user interface may have a display and/or receipt printer.

In the illustrated example, the FPS 106 of controller 106 is coupled to a payment processor 112 via a link 114. The payment processor 112 is operable to receive requests for payments from POS terminal 102 The payment processor, which in an example embodiment is remote from the POS terminal 102 is responsible for approving or declining payment requests for a transaction and for causing the appropriate accounts (e.g., financial accounts such as checking, credit card, etc.) to be debited or credited. As will be illustrated in example embodiments herein, FPS 106 manages a flow for processing payments and communicating with payment processor 112.

The link 114 coupling the POS terminal 102 with the Payment Processor 112 can be any suitable type of link for providing communication between the POS terminal 102 with the Payment Processor 112. For example, link 114 may comprise wired, wireless, or a combination of wired and wireless links.

In an example embodiment there is described herein a solution (referred to herein as “Appflow”) that provides merchants and merchant acquirers with flexible and powerful options for tailoring and shaping their point of sale (“POS”) experience. They can accomplish this by using whatever device(s) they want, adding any value added services relevant for that merchant and connecting to payment services of their choice to ultimately charge the customer.

AppFlow enables applications to be called at different stages of the point of sale journey. What stages exist and what applications are called depends on the flow applied to that particular request. The flow applied is determined by the type of the request, such as sale or reversal.

There are two main types of AppFlow applications. These are Flow initiators and Flow services.

Flow Initiators

Flow initiating applications is what the merchant/operator uses to enter details for a particular function. A classic example would be to scan customer goods into a basket in order to take a payment. AppFlow is however not restricted to transaction style flows and allows for any form of function to be initiated, such as updating inventory or registering a customer for loyalty purposes. POS or Electronic Cash Register (“ECR”) applications can employ the Payment Initiation API to query AppFlow for information, and to initiate flows with request data tailored for that flow.

Flow Services

Flow services are applications that adhere to the Payment Flow Service API and get called in a flow to perform some function, such as loyalty or processing payments. There is no limit on the number of flow services that can be called for any given flow or stage.

The flow services can be divided into two main groups;
Payment applications, which processes the actual payments
Value added applications, such as loyalty or split bill

Illustrated in FIG. 2, is an example of a system 200 that employs a Flow Processing Service (FPS) 206 that is the core component that handles all requests and moves them through a “flow”. In the illustrated example, a flow initiating application 202 sends a request 204 that is processed by flow processing system (“FPS”) 206. The FPS 206 processes the flow as independent stages. In the illustrated example, there are three stages 210, 220, 230. The first stage 210 is comprised of three applications 212, 214, 216. The second stage is comprised of three applications 222, 224, 226. The third stage is comprised of three applications 232, 234, 236. As those skilled in the art can readily appreciate, the number of stages and the number of applications per stage in the illustrated example were selected for ease of illustration and that a flow processed by FPS 206 may have any physically realizable number of stages and that each stage may have any physically realizable number of services (applications). After the stages 210, 220, 230 have been processed, a response 240 is returned to the flow initiating application 202.

Once the FPS 206 is installed onto a device, developers will be able to use predefined APIs to initiate requests and implement value added services and payment service applications. In an example embodiment, the FPS 206 is implemented as an Android service and is always running. Although in the examples illustrated herein the FPS 206 is handling financial transactions those skilled in the art can readily appreciate that it is generic and can be used for processing any kind of request that may need to be moved through some form of flow consisting of various applications.

The FPS 206 maps a request to a flow via the request type. Examples of request types are: sale, refund, pre-authorization etc. These payment related types may all have a different flow. For instance, a sale may be sent through a split stage (to split the bill) but a refund probably won't be. The flows and request types that are supported by FPS are fully customizable. The production flows will usually be defined by the bank, acquirer or payment processor distributing AEVI enabled devices. AEVI provides a default set of flows.

Flow Stages

The flow stages determine what applications are called and how they are called. For example, for POS and ECR processes, there are three main types of flows that will impact what stages are available;
Payment flows, which involve the transfer of money from one party to another, such as sale/purchase or refund.
Generic flows, which are designed to support any custom/bespoke scenario where the request/response models can hold any arbitrary data. Examples are tokenization and batch closure.
Status update flows, which allow an application to inform other applications of some status/state change, such as basket or customer updates.

Generic Flows

The generic flows are a lot simpler than the payment flows and have two possible stages, the Generic stage and Post-Generic stage.

The generic stage is where the request is processed. As an example, for a request of type tokenization, this is where a payment app would read a card and generate a token. There Generic state has one service handling a generic request and passing back a response via the.

This is the generic equivalent of Post-flow, where an app gets called with the final response and can review that data. It can also add references to the response.

Status Update Flows

Status update flows are similar to generic flows in terms of how they are initiated and what models are used, but the execution of the flows are different. In an example embodiment, there is just a Status Update stage that may contain one to many applications that get called in sequence for the purpose of getting access to the requested data. This flow can be executed entirely in the background from a special request queue and can process in parallel to payment and generic foreground flows Applications can fetch the data and optionally add references.

Applications

In an example illustrated herein, there are three groups of applications in AppFlow which will be described in more detail infra.
1) POS (Point of Sale) applications—the application used by the merchant to take orders and manage payments
2) Flow applications—the VAAs that can be called throughout the POS journey to provide services
3) Payment applications—the apps typically developed by (or on behalf of) the acquirer that transacts with the acquirer host

POS Applications

POS applications are what the merchant/operator uses to input the details of a transaction, such as choosing items for a customer order or scanning item barcodes. In AppFlow, these applications use the Payment Initiation API to create payment requests for processing and receiving the result of that processing.

POS applications have some influence over the flow itself, in that they can choose to enable or disable split, force a particular payment service to be used, pass token details, etc.

Flow Applications, Value Added Applications (“VAAs”)

Flow applications, also known as Value added services, are implemented by third party developers as applications that adhere to the Flow Service Application Programming Interface (“API”). The FPS is able to assess the capabilities of the flow service API and is therefore able to call it at the correct time. The services themselves can perform many different tasks that will benefit the merchant and/or customer. These applications will augment a request in some way by applying a discount or converting the initial request in some way, but may also link to other third party services locally or networked. Some examples for flow services include, but are not limited to:
loyalty programs
charity donations
split bill
ratings
advertising and promos
currency conversion
receipt printing/emailing.

The services specify that they are to be called at one or more “stages” in a flow for particular request type(s). The services themselves provide information to the FPS to indicate when they are to be called, what request types they support and various other parameters.

Payment Applications

The payment applications are defined as flow services that execute in the transaction processing stage. They may optionally also support the card reading stage where a card may be presented separately to the processing of the payment, to allow for other flow services to react on the given card data, such as token or scheme. These forms of applications can be developed by or on behalf of the acquirer/bank, but can also be independent payment solutions where a customer pays via cash, vouchers, QR codes, etc.

Payment services are usually implemented by the acquiring bank or by a development of payment application specialists on behalf of the bank/processor. These applications implement the Payment Service API. This API allows the FPS to assess the capabilities of the payment service(s) installed on a device and present these capabilities back to users of the Payment Initiation API.

There is no limit on the number of payment service applications that can be installed on a device although in practice it is often the case that there will be only one. If more than one payment service is installed and a request sent to the FPS is capable of being processed by more than one of the services, the FPS will present a selection dialog to the user/merchant allowing them to specify which payment service to use. Developers using the Payment Initiation API can force the use of a particular payment service by specifying the payment service ID when making the initial request. The payment service IDs are available via the Payment Initiation API.

In the examples illustrated herein, there are three separate APIs, the Payment Initiation API, the Flower Service API, and the Payment Service API, each with an associated sample app. In particular embodiments, the Flow Service and Payment Service APIs can be merged.
Payment Initiation API—Provides general flow and system information and allows apps to initiate financial requests
Flow Service API—Provides an integration point for flow applications to be called throughout the POS journey
Payment Service API—Provides an integration point for payment processing services (usually implemented by acquirers/banks)

Payment Initiation API

The Payment Initiation API allows an application (such as, for example, a POS app) to initiate a payment. It also provides various functions to query the system for information about the flow services and payment services available for use. This API is employed for building a POS application.

Flow Service API

The Flow Service API allows for applications to be called throughout the payment flow and provide capabilities. This API is employed for building a “value added service”, such as loyalty, charity, currency conversion, receipt generation, printing, etc.

Payment Service API

The Payment Service API allows a payment service/application to process payment requests and charge an amount to the customer, normally via a payment card. This API is employed for building a payment application that can charge a customer via any supported payment method.

It should be noted that although in the example embodiments described herein the APIs define Plain Old Java Objects (“POJOs”) for client apps to use, all data is represented as JavaScript Object Notation (“JSON”). The POJOs are serialized to JSON whenever it is passed across any Inter-Process Communication (“IPC”) barriers and the system itself is mainly concerned with JSON structures. Those skilled in the art should readily appreciate that the example embodiments described herein may be implemented using any suitable technique.

In the examples described herein, the APIs are primarily Java based, but as the underlying representation is JSON there is no real language restriction from a system point of view. Kotlin is implicitly supported due to its interoperability with Java. In particular embodiments, Javascript is also supported. Other languages (compatible with the Java Virtual Machine “JVM”) can be supported but may require a translation layer on the client side.

The Flow Processing Service

A Flow Processing Service (FPS) is a service that is capable of running a request through a flow and returning a response. Each “flow” is domain/category specific and comprises one or more “stages” for each “type” of request that can be made within the domain/category. Each domain/category can define any number of request “types” that can each have their own “flow”

Each “stage” of the flow can optionally execute any number of “flow applications” (could be none). These applications can be configured by the user according to what apps are available on the device or any other connected device on the user's network.

Each “flow application” will process some data that has been sent to it and respond with its own data. The data sent between FPS and the flow application is domain/category specific.

The FPS can handle financial transactions but is actually generic. The FPS can potentially be used for other purposes for other domains/categories.

Flows in the Point of Sale Domain

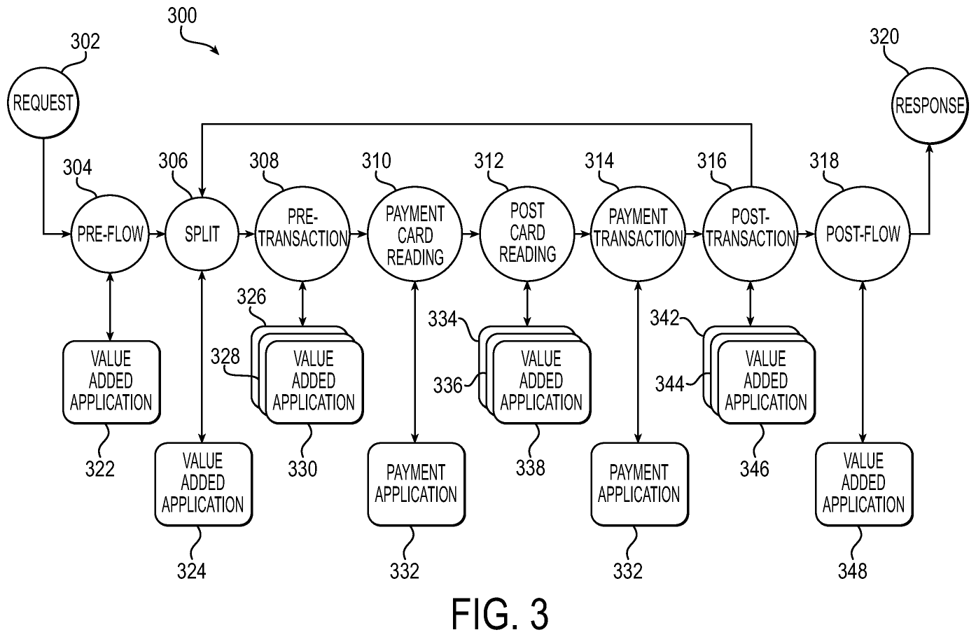

For the point-of-sale domain/category the FPS processes financial request through the payment “flow”. An example POS-flow is illustrated in FIG. 3 below for the basic “sale” request type.

The POS-flow domain has several request types which are standard financial transaction types e.g:
sale—Take a payment
refund—Give a refund
pre-authorization—Make a pre-authorization request on a customer's account
pre-auth-completion—Complete a pre-authorization
token—Get a unique token for a customer (usually from a payment and/or loyalty card)

Each of these request types has its own flow that can be customized within the FPS. At certain stages in the flow zero, one of many flow applications may be called if they are configured against the flow. For example, in the post-card reading stage a flow application may be called to perform a customer loyalty function.

For payment domains the list of available request types is completely controlled by the payment applications available on the users device(s). This means that payment applications are not restricted to the request types defined above. Developers can create any new request types they choose. In an example embodiment, the FPS is configured with a fixed set of request types that it can handle with all other types being handled by a simplified default flow. In other embodiments, the FPS will allow for the request types to be configured dynamically.

FIG. 3 is a diagram illustrating an example of a payment flow 300 with supported stages 304, 306, 308 310, 312, 314, 316, 318. The only mandatory stage is the Payment Transaction stage 314—all other stages 304, 306, 308, 310, 312, 316, 318 are optional. FIG. 3, further illustrates the distinction between payment applications and value added applications based on the stage of the flow are illustrated. The flow is initiated by request 302 and when completed a response 320 is provided.

The Pre-Flow stage 304 is executed immediately after the source Payment has been received and validated. It is executed only once per flow, regardless of whether the flow is split or not.

The Pre-flow stage 304 is designed to handle the use cases where an application other than a POS application initiates a flow. As an example, a loyalty app might be the first point of interaction with a customer where they identify themselves. In order to pass this information onto a payment flow (without using bespoke integrations), the loyalty app 322 can initiate a zero based amounts payment with associated customer data. The POS application will then be called in the pre-flow stage 304 where it can perform its normal function and update the relevant data before the flow continues.

In an example embodiment by default, the pre-flow stage 304 is called for cases where the payment amounts are zero. This is setting is configurable. A pre-flow app can set data or it may also cancel the flow.

If a split application 324 is installed and the request has enabled split, the split stage 306 will be executed where the application can split the flow into one or more individual transactions. The most common use case of this is to allow a group of customers to split the bill, either based on amount or via basket items.

A split app 324 can update the base amount and/or basket for the next transaction. It may also cancel the flow.

The Pre-Transaction stage 308 allows an application to modify request data before any potential payment card is read, assuming that there is a payment application that reads cards and supports the optional payment-card-reading stage 310.

For most applications, post-card-reading stage 312 will be a more appropriate stage as card details may then also be available, allowing an informed choice of how to identify a customer.

A pre-transaction app (e.g., 326, 328, or 330) can do things like;
Add amounts (like charity donation or a fee)
Add baskets
Pay off a portion or all of the requested amounts
Apply discounts to baskets/basket items
Add or update customer details

The Payment Card Reading stage 310 is an optional stage that a payment application (or “app”) 332 may or may not support. Note that there is no guarantee that payment applications even use payment cards as a payment method—it could be cash, QR codes, etc.

If the stage 310 is supported and the card reading is successful, card data will be available for the remaining stages 312, 314, 316, and 318.

A payment app 332 can validate a payment card or decline the transaction.

The Post-Card Reading stage 310 is executed after the optional payment card reading stage 310, meaning there may or may not be valid card data available. one or more of value applications 334, 336, 332 may be executed based on the card data.

At the Payment Transaction (Transaction Processing) stage 314, the payment app 314 processes the payment based on the data provided (which may or may not have been augmented in previous stages). At the end of this stage 314, a Transaction Response is sent indicating the outcome of the transaction.

At the Post-Transaction stage 316, Transaction Summary will be passed to applications (for example applications 342, 344, 346) in this stage 316, which contains a breakdown of the input transaction data and a list of transaction responses for that transaction. It will also contain the card data if any was set by the payment application at either payment app stage. In an example embodiment, this application can augment points in a loyalty program.

If there is a split payment and another payment is to be processed, the flow returns to stage 306 for the next payment. Otherwise, the flow proceeds to the Post-Flow stage 318.

The Post-Flow stage 318 is executed after the flow is completed and a final Payment Response object has been created which is made available for applications (e.g., application 348) at this stage 318. There are no options to augment any data as the flow has completed. A post-flow app 348 may however choose to keep executing in the background in parallel to the flow.

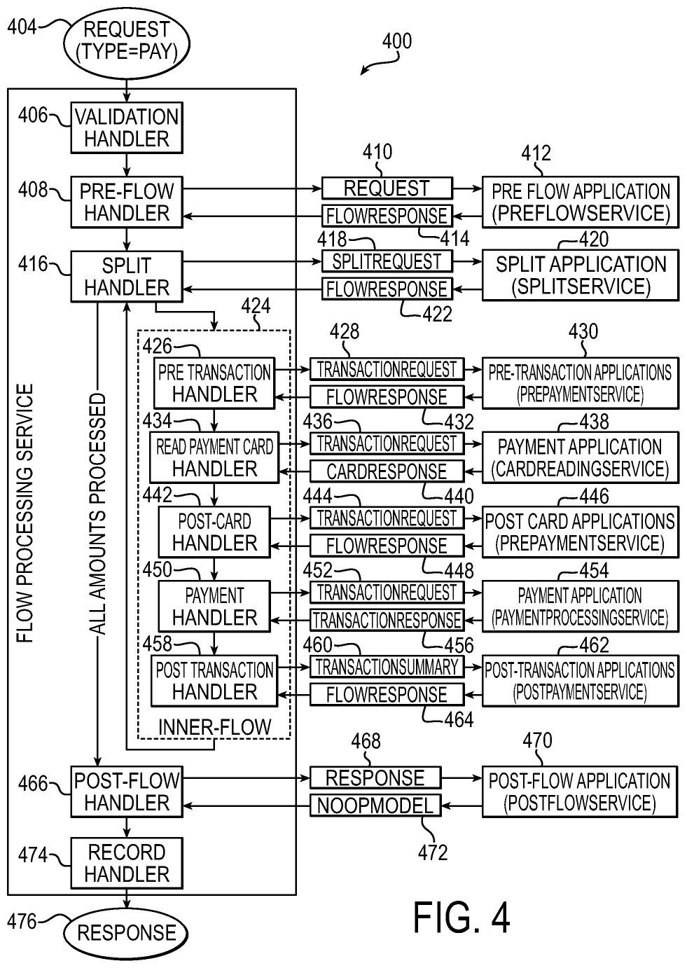

FIG. 4 is a more detailed block diagram illustrating an example of a Point of Sale (“POS”) flow 400 that employs a flow processing service 402 for processing stages of a flow in accordance with an example embodiment. The flow is initiated at 404 when a request is sent by an initiating application (not shown, see e.g., ref. 202 in FIG. 2). In the illustrated example, the request type is pay indicating that a payment flow is requested.

In response to the request 404, the FPS 402 begins processing the flow for the requested type. The FPS 402 begins by processing a validation handler 406. Processing then proceeds to the Pre-Flow handler state 408.

The Pre-flow handler stage 408 is designed to handle the use cases where an application other than a POS application initiates a flow. As an example, a loyalty app might be the first point of interaction with a customer where they identify themselves. In order to pass this information onto a payment flow (without using bespoke integrations), a loyalty app can initiate a zero based amounts payment with associated customer data. The POS application will then be called in the pre-flow stage 304 where it can perform its normal function and update the relevant data before the flow continues.

In the example illustrated in FIG. 4, the Pre-Flow handler 408 sends a request 410 to the Pre-Flow application 412. After processing the request, the Pre-Flow application 412 sends a response 414 to the Pre-Flow handler 408.

If a split application 420 is installed and the request for the flow has indicated a split payment, the Split Stage handler 416 will send a request 418 to the Split application 420. The Split application 420 can split the flow into one or more individual transactions. The most common use case of this is to allow a group of customers to split the bill, either based on amount or via basket items. The split app 420 can update the base amount and/or basket for the next transaction. It may also cancel the flow.

The Inner flow 424 is processed until all of the payments have been processed. In the case of a single payment, the Inner flow 424 is processed once. The Inner flow 424 comprises the Pre-transaction stage, Read Payment card stage, Post Card-read stage, Payment stage and Post Transaction stage.

The Pre-Transaction stage is processed by the Pre-transaction hander 426 that allows an application 430 to modify request data before any potential payment card is read, assuming that there is a payment application that reads cards and supports the optional payment-card-reading of Pre-Transaction stage. The Pre-Transaction handler 426 sends a request 428 to the Pre-transaction application 430. The Pre-transaction application 420 can perform tasks such as add amounts (like charity donation or a fee) to the transaction, add baskets to the transaction, pay off a portion or all of the requested amounts, apply discounts to baskets/basket items, and add or update customer details. The Pre-Transaction application 430 can handle one of the aforementioned tasks and call other applications (not shown) to perform other tasks and receive a response when the tasks are completed. Upon completion, the Pre-Transaction application 430 sends a response 432 to the Pre-Transaction handler 426.

The Payment Card Reading stage is an optional stage that a payment application may or may not support. Note that there is no guarantee that payment applications even use payment cards as a payment method—it could be cash, QR codes, etc.

The Payment Card Reading stage is implemented by the Read Payment Card handler 434. The Read Payment Card handler 436 sends a request to the Payment application 438. Upon completion, the Payment application sends response 440.

If the card reading stage is supported and the card reading is successful, card data will be available for the remaining stages of the flow. The payment app 438 can set card details or decline the transaction (e.g., card can't be read or invalid card).

The Post-Card Reading stage is processed by the Post card handler 442. The Post-card handler 442 sends a request 444 to the Post Card Payment application 446. Upon completion, the Post Card Payment application 446 sends a response 448 to the Post Card handler 442.

The Payment Transaction (Transaction Processing) stage is implemented by the Payment handler 450. The Payment handler 450 sends a request 452 to Payment application 454. Upon completion, the Payment application 454 sends a response 456 to the Payment handler 450.

The payment app 454 processes the payment based on the data provided (which may or may not have been augmented in previous stages). At the end of this stage, a Transaction Response is sent indicating the outcome of the transaction (e.g., approved or declined).

At the Post-Transaction stage is implemented by the Post Transaction Handler 458. The Post Transaction handler send a request 460 to Post transaction application 462. Upon completion, the Post Transaction application sends a response 462 to the Post Transaction handler 458.

A transaction summary can be passed to applications (for example application 462) in this stage, which contains a breakdown of the input transaction data and a list of transaction responses for that transaction. It can also contain the card data if any that was set by the payment application at either payment app stage 438, 454. In an example embodiment, this application can augment points in a loyalty program, obtain ratings, provide advertising and promotions, and/or receipt printing/emailing.

The flow returns to the Split handler 416. If there is a split payment and another payment is to be processed, the flow is again processed by the Pre Transaction handler 426, Read Payment Card handler 434, the Post Card handler 442, Payment handler 450, and Post Transaction handler 458 and the appropriate associated applications (e.g., Pre-Transaction application 430, Payment application 438, Post Card application 446, Payment Application 454, Post Transaction application 462) for the next payment. Otherwise, the flow proceeds to the Post-Flow stage.

The Post-Flow stage is implemented by the Post Flow handler 466. The Post Flow handler 466 sends a request 468 to the Post-Flow application 470. Upon completion, the Post-Flow application 470 sends a response 472 to Post Flow handler 466.

The Post-Flow application is executed after the flow is completed and a final Payment Response has been processed which is made available for other applications. There are no options to augment any data as the flow has completed.

The final stage handled by the FPS 402 is the Record handling stage. This stage is implemented by Record handler 474. The Record handler provides a Response 476 to the initiating application.

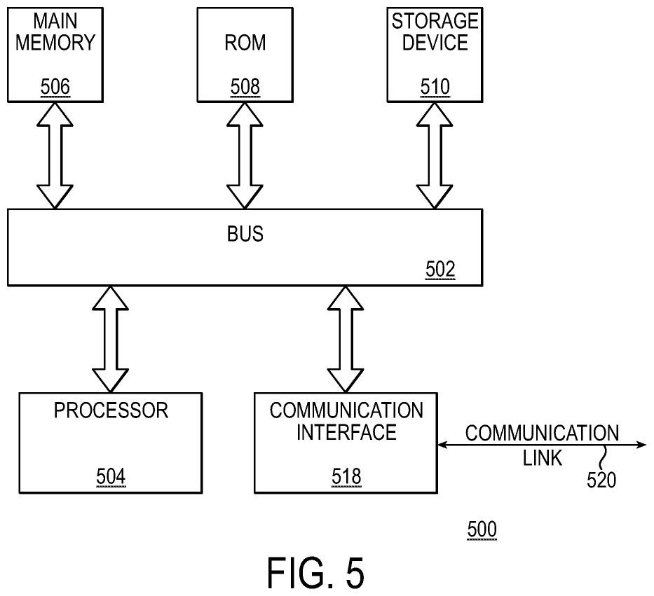

FIG. 5 is a block diagram that illustrates a computer system 500 upon which an example embodiment may be implemented. Computer system can be employed for implement any of the controller 104 and/or FPS 106 of the POS terminal 102 in FIG. 1, FPS 206 in FIG. 2, payment flow 300 in FIG. 3, and/or FPS 402 in FIG. 4.

The computer system 500 includes a bus 502 or other communication mechanism for communicating information and a processor 504 coupled with bus 502 for processing information. Computer system 500 also includes a main memory 506, such as random access memory (RAM) or other dynamic storage device coupled to bus 502 for storing information and instructions to be executed by processor 504. Main memory 506 also may be used for storing a temporary variable or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk, optical disk, or solid state disk is provided and coupled to bus 502 for storing information and instructions.

An aspect of the example embodiment is related to the use of computer system 500 for Process Flow Management. According to an example embodiment, Process Flow Management is provided by computer system 500 in response to processor 504 executing one or more sequences of one or more instructions contained in main memory 506. Such instructions may be read into main memory 506 from another computer-readable medium, such as storage device 510. Execution of the sequence of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 504 for execution. Such a medium may take many forms, including but not limited to non-volatile media. Common forms of computer-readable media include for example, hard disk, magnetic cards, paper tape, any other physical medium with patterns of holes, a RAM, a PROM, an EPROM, a FLASHPROM, CD, DVD, SSD or any other memory chip or cartridge, or any other medium from which a computer can read.

Computer system 500 also includes a communication interface 518 coupled to bus 502. Communication interface 518 provides a two-way data communication coupling computer system 500 to a communication link 520. In an example embodiment, the communication link 520 is connected to a local network 522. For example, communication interface 518 may be a local area network (LAN) card to provide a data communication connection to a compatible LAN. As another example, communication interface 518 may be an integrated services digital network (ISDN) card or a modem to provide a data communication connection to a corresponding type of telephone line. Wireless links may also be implemented. In any such implementation, communication interface 518 sends and receives electrical, electromagnetic, or optical signals that carry digital data streams representing various types of information.

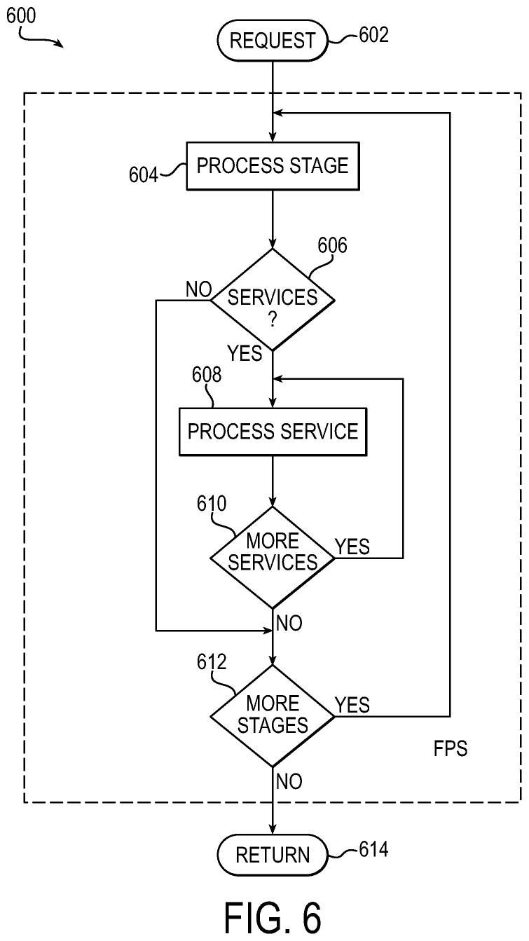

In view of the foregoing structural and functional features described above, methodologies in accordance with an example embodiment will be better appreciated with reference to FIGS. 6-11. While, for purposes of simplicity of explanation, the methodologies of FIGS. 6-11 are shown and described as executing serially, it is to be understood and appreciated that the example embodiment herein are not limited by the illustrated orders, as some aspects could occur in different orders and/or concurrently with other aspects from those shown and described herein. Moreover, not all illustrated features may be required to implement the methodologies described herein. The methodologies described herein are suitably adapted to be implemented in hardware, software when executed by a processor (e.g, by computer system 500), or a combination thereof.

FIG. 6 is a block diagram illustrating an example of a methodology 600 implemented by the flow processing service described herein. The methodology is initiated by a request 602 that calls the appropriate API for the type of flow being processed.

At 604 a stage in the flow is processed. For example, the first stage processed can be a Pre-Flow stage and the last stage processed can be a Post-Flow stage.

At 606, a determination is made whether there are services (programs) to be processed by the stage. If there are services (YES), the flow proceeds to process the a service as indicated at 608. If there are no services to be processed at 606 (NO), the flow proceeds to 612 to determine whether there are more stages to be processed. If, at 612, there are more flows to process (YES) the flow returns to 604 to process the next stage. Otherwise (NO), the flow proceeds to 614 and returns to the calling application (or flow).

After a service (program) has been services at 608, at 610 a determination is made whether there are more services to process. If there are (YES), the flow returns to 608 to process the next service. Otherwise, the flow continues to 612 where a determination is made whether there are more stages to process.

If, at 612, there are more stages to process (YES), the flow returns to 604 to process the next stage. Otherwise (NO), the flow is completed and at 614 a response is sent to the calling application or flow.

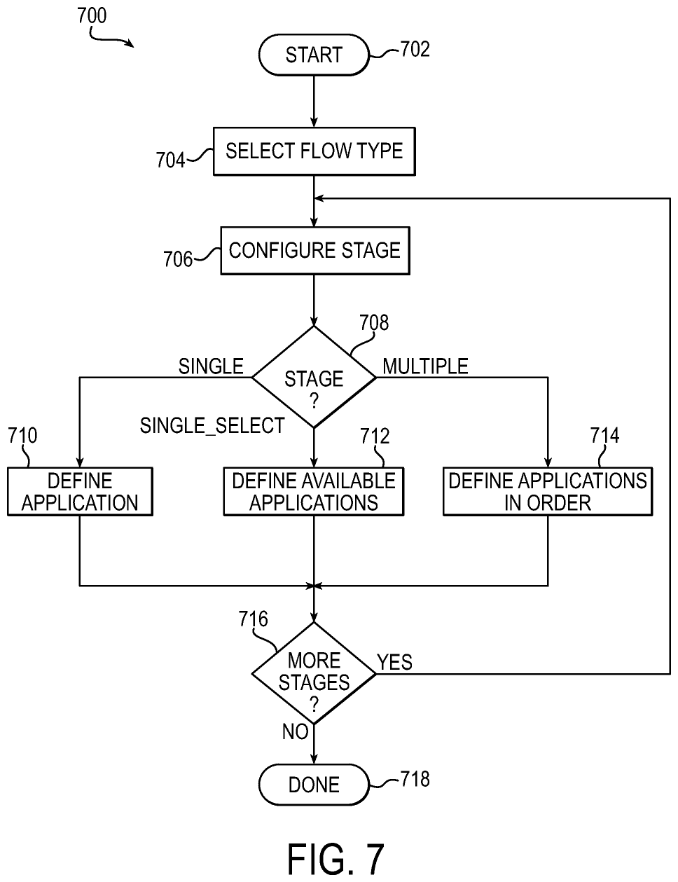

FIG. 7 is a block diagram illustrating an example of a methodology 700 for a developer to implement a Value Added Application (VAA) for use with the flow processing service described herein. The methodology 700 begins at 702. At 704, the developer selects flow type, such as for example, the payment API described herein, although any flow type can be input.

At 706, the developer configures a stage for the flow. At 708, the application execution type is determined. An application executing type can be associated with each stage and determines how the FPS will execute the applications in that stage.

If, at 708, the flow configuration type for the stage is SINGLE, a single application is defined for the stage as indicated at 710. If, at 708, the flow configuration type for the stage is SINGLE_SELECT, then multiple applications can be defined for a stage but only when will be executed. Runtime filtering and/or a selection will determine which one of the defined applications will be executed. If, at 708, the flow configuration type for the stage is MULTIPLE, then multiple applications can be defined and they will be called one by one in order of definition.

After the completion of either 710, 712, or 714 a determination is made whether there are more stages to be configured. If there are more stages to be configured (YES), the methodology 700 returns to 706 to configure the next stage. Actions 706, 708, 710, 712, and 714 may be repeated as many times as necessary until all of the stages of a flow have been configured.

If, at 716, there are no more stages to configure (NO), at 718, the methodology 700 is completed as indicated at 718.

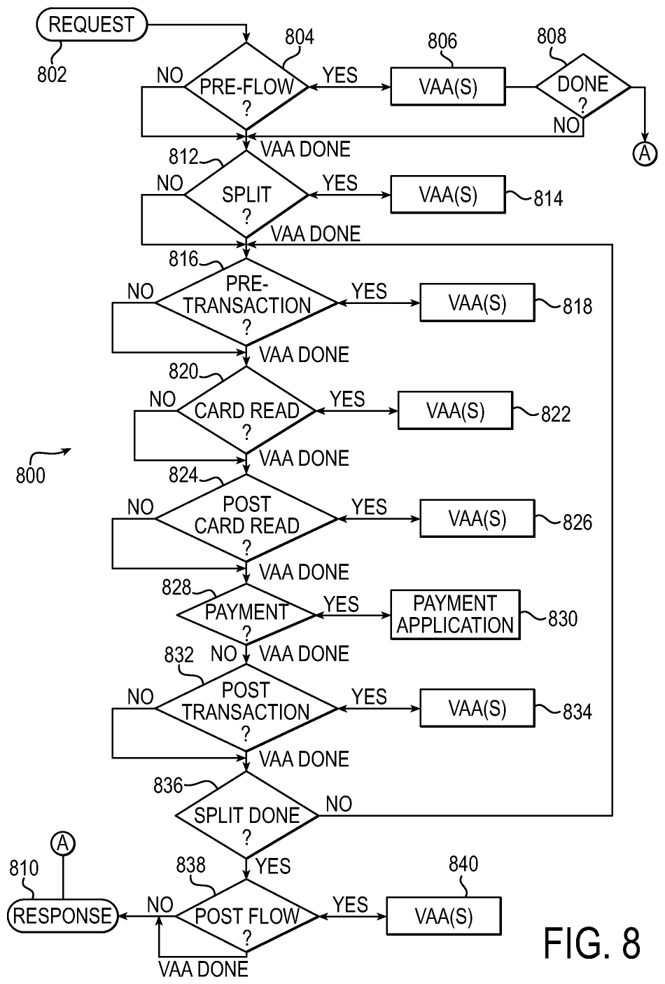

FIG. 8 is a block diagram illustrating an example of a methodology 800 for a payment processing flow implemented by the flow processing service described herein. In the illustrated example, the payment state 824 is mandatory and the payment application 826 must be executed. The flow is initiated by request 802 that employs an API as described herein.

At 804, a determination is made whether a Pre-Flow stage is to be processed. If a flow is to be processed (YES), any Value Added Applications (VAAs) 806 for the flow are executed. In an example embodiment, the Pre-Flow stage is executed immediately after the request to initiate the Payment flow has been received and validated. In particular embodiments, the Pre-Flow stage is executed only once per flow, regardless of whether the flow is split or not.

In an example embodiment, the Pre-flow stage is designed to handle the use cases where an application other than a POS application initiates a flow. As an example, a loyalty app might be the first point of interaction with a customer where they identify themselves. In order to pass this information onto a payment flow (without using bespoke integrations), the loyalty app can initiate a zero based amounts payment with associated customer data. The POS application will then be called in the pre-flow stage 304 where it can perform its normal function and update the relevant data before the flow continues.

In an example embodiment by default, the pre-flow stage is called for cases where the payment amounts are zero. This is setting is configurable. A pre-flow app can set data or it may also cancel the flow.

After the VAA(s) are processed at 806, If, at 808, there are no more stages to be processed after the Pre-Flow stage (e.g., the payment amount is zero) (YES), the flow proceeds to 810 and a response is sent back to the calling application. Otherwise (NO) or after the VAA(s) are done executing (VAA DONE), the flow proceeds to 812.

At 812, a determination is If a split application is installed and the request has enabled split. If the application is installed and a split is requested (YES), any split stage VAA(s) 814 will be executed where the application can split the flow into one or more individual transactions. The most common use case of this is to allow a group of customers to split the bill, either based on amount or via basket items.

A split app can update the base amount and/or basket for the next transaction. It may also cancel the flow.

At 816, a determination is made whether the Pre-Transaction stage should be implemented. If the Pre-Transaction stage is implemented (YES), the stage is implemented and any VAA(s) 818 for that stage are executed. Otherwise (NO) or after the VAA(s) are done executing (VAA DONE), the flow continues to 820.

The Pre-Transaction stage allows an application to modify request data before any potential payment card is read, assuming that there is a payment application that reads cards and supports the optional payment-card-reading stage.

A pre-transaction app (e.g., 818) can do things like;
Add amounts (like charity donation or a fee)
Add baskets
Pay off a portion or all of the requested amounts
Apply discounts to baskets/basket items
Add or update customer details

At 820, a determination is made whether the Card Reading stage should be implemented. If the Pre-Transaction stage is implemented (YES), the stage is implemented and any VAA(s) 822 for that stage are executed. Otherwise (NO) or after the VAA(s) are done executing (VAA DONE), the flow continues to 824.

The Payment Card Reading stage is an optional stage that a payment application (or “app”) 830 may or may not support. Note that there is no guarantee that payment applications even use payment cards as a payment method—it could be cash, QR codes, etc.

A payment app 830 can validate a payment card or decline the transaction.

If the Card Reading stage is supported and the card reading is successful, card data will be available for the remaining stages, including their applications (e.g., applications 826, 830, and 834).

At 824, a determination is made whether the Post Card-Reading stage should be implemented. If the Post Card-Reading stage is implemented (YES), the stage is implemented and any VAA(s) 826 for that stage are executed. Otherwise (NO) or after the VAA(s) are done executing (VAA DONE), the flow continues to 828.

The Post-Card Reading stage is executed after the optional payment card reading stage, meaning there may or may not be valid card data available. one or more of VAA(s) 826 may be executed based on the card data.

For most applications, post-card-reading stage will be a more appropriate stage for adding amounts, adding baskets, updating customer information, and/or applying discounts as card details would be available, allowing an informed choice of how to identify a customer.

The payment transaction stage is implemented at 828. Any payment applications 830 are executed during this stage.

At the Payment Transaction (Transaction Processing) stage, the payment app 830 processes the payment based on the data provided (which may or may not have been augmented in previous stages). At the end of this stage, a Transaction Response is sent indicating the outcome of the transaction.

At 832, a determination is made whether the Post Transaction stage should be implemented. If the Post Transaction stage is implemented (YES), the stage is implemented and any VAA(s) 834 for that stage are executed. Otherwise (NO) or after the VAA(s) are done executing (VAA DONE), the flow continues to 836.

At the Post-Transaction stage, a Transaction Summary will be passed to applications (for example applications VAA(s) 834) in this stage, which contains a breakdown of the input transaction data and a list of transaction responses for that transaction. It will also contain the card data if any was set by the payment application at either payment app stage. In an example embodiment, this application can augment points in a loyalty program.

If there is a split payment, at 832, a determination is made whether another payment is to be processed. If and another payment is to be processed (YES), the flow returns to 816 for the next payment. Otherwise, the flow proceeds to the Post-Flow stage at 838.

At 838, a determination is made whether the Post Flow stage should be implemented. If the Post Flow stage is implemented (YES), the stage is implemented and any VAA(s) 840 for that stage are executed. Otherwise (NO) or after the VAA(s) are done executing (VAA DONE), the flow is completed, and a response is sent as indicated by 810.

The Post-Flow stage is executed after the payment flow is completed and a final Payment Response object has been created which is made available for applications (at this stage (e.g., VAA(s) 840). There are no options to augment any data as the flow has completed. A post-flow app 840 may however choose to keep executing in the background in parallel to the flow.

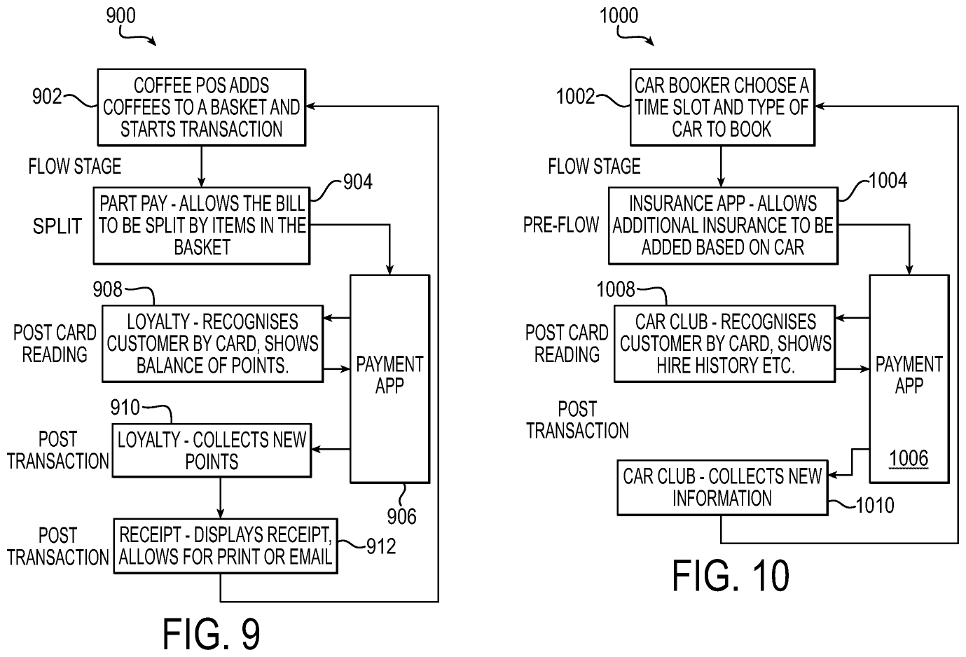

FIG. 9 is a block diagram illustrating an example of a simplified methodology 900 for processing a payment for a coffee shop. At 902, the Coffee POS adds coffees to the basket and starts a transaction. At the split flow stage, a Partial payment option allows the bill to be split by items in the basket as indicated by 904. This data is provided to the Payment App 906.

The flow then proceeds from the Payment App 906 to the Post Card reading stage. At the post Card Reading stage, a customer loyalty program recognizes the customer by the card and shows the customer their point balance as indicated at 908.

After the Post Card Reading stage, the flow returns to the Payment App 906 for processing the payment. The Payment App 906 can use points from the customer loyalty program and/or funds from the card to obtain payment.

When the Payment App 906 is done processing the payment the flow proceeds to the Post Transaction stage. At the Post Transaction stage, the customer's loyalty program points may be updated with new points from the current transaction as indicated by 910. The Post Transaction stage may also provide a receipt to the customer (paper and/or email) as indicated by 912. After processing of the flow is completed, a return to the calling program is made.

FIG. 10 is a block diagram illustrating an example of a simplified methodology 1000 for implementing a payment process flow for a car rental. The flow is started when a Request 1002 is received from a Car Broker application where a time slot and type of car is selected.

At the Pre-Flow stage, an Insurance Application allows additional insurance to be added based on the car as indicated by 1004. Taxes, airport fees, and other additional fees may be added at the Pre-Flow stage.

After the Pre-Flow stage, the flow proceeds to the Payment App 1006. The Payment App may obtain payment information (e.g., how the payment is being made and obtain card data, codes, etc.).

The flow then proceeds from the Payment App 1006 to the Post Card Reading stage. At this stage, a Car Club can recognize a customer based on their card. The Car Club can collect information for the new booking as indicated at 1010. After the car clubs collects the information, the flow ends and processing returns to the requesting application.

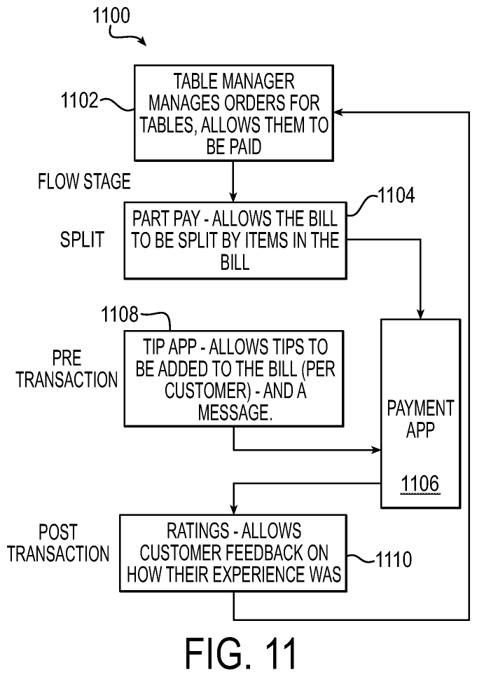

FIG. 11 is a block diagram illustrating an example of a methodology 1100 for implementing a payment process flow for a restaurant. The application is called by a Table Manager App that manages orders for a table and allows payments to be split as indicated by 1102.

At the Split stage, partial payments are excepted, such as for example for individual items or a portion of the total as indicated by 1104. As the flow moves to the Pre-Transaction stage, a Tip App allows tips to be added to the bill per customer and a message may be provided as indicated by 1108.

The flow then proceeds to the Payment App 1106 which collects the partial payment and tip. The flow proceeds to the Post Transaction stage.

At the Post Transaction stage, a Ratings App allows customer feedback about their experience as indicated at 1110. For split applications, the Pre-Transaction and Post Transaction stages just described can be repeated for each person providing a partial payment. Upon completion of the payment, the flow returns to the calling application.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. A method comprising:
receiving from a source a payment flow request for a implementing a payment flow for a payment transaction using a predefined application programming interface, the payment flow comprises a plurality of predefined stages;
processing, by a flow processing service, a Pre-Flow stage, the processing of the Pre-Flow stage comprises executing a value added application;
processing, by the flow processing service, a payment transaction stage that comprises a payment application that obtains the funds for the transaction; and
processing, by the flow processing service, a Post-flow stage that comprises executing a value added application; and
providing a response to the source;
wherein at least one of the Pre-Flow stage, Post-Flow stage, or both the Pre-Flow stage and Post-Flow stage comprises a plurality of value added applications that are executed during processing of a stage having the plurality of value added applications.

2. The method according to claim 1, further comprising processing, by the flow processing service, a Pre-Transaction stage that comprises a Pre-Transaction stage value added application.

3. The method according to claim 2, wherein the Pre-Transaction stage value added application is operable to perform a pre-transaction task selected from a group consisting of add amounts to the transaction, add baskets to the transaction, apply a discount to the transaction, and update customer details.

4. The method according to claim 3, further comprising processing, by the flow processing service, a Payment Card Reading stage that comprises a Payment Card Reading stage value added application.

5. The method according to claim 4, wherein the Payment Card Reading stage value added application is operable to obtain card data and indicate whether a card read was successful.

6. The method according to claim 5, further comprising processing, by the flow processing service, a Post-Card Reading stage that comprises a Post-Card Reading stage value added application.

7. The method according to claim 6, wherein the Post-Card reading stage value added application is operable to perform a card reading task selected from a group consisting of determining a loyalty program associated with a cardholder and providing data representative of a current point balance, and locating past transactions based on card data and providing data representative of past transactions.

8. The method according to claim 7, further comprising processing, by the flow pressing service, a Post Transaction stage that comprises a value added application.

9. The method according to claim 8, wherein the value added application of the Post transaction reading stage is operable to perform a post transaction task selected from the group consisting of providing a receipt and updating a customer loyalty program with data representative of the payment transaction.

10. The method according to claim 9, further comprising
processing, by the flow processing service, a Split Payment application that comprises a Split Payment stage value added application;
wherein the Split Payment application allows for payment to be received from multiple parties; and
wherein for each of the multiple parties, the flow processing service processes the Pre-Transaction stage, Payment Card Reading stage, Post Card Reading stage payment transaction stage, and the Post-Transaction stage.

11. A method, comprising:
receiving from a source, a request to implement a flow employing a flow processing service with a predefined application programming interface that defines a plurality of stages to be executed by the flow processing service; and
processing the plurality of stages for the flow;
wherein at least one of the plurality of stages comprises a plurality of value added applications.

12. The method according to claim 11, wherein one of the plurality of stages has a stage type of single that limits the stage to a single value added application.

13. The method according to claim 11, wherein one of the plurality of stages has a stage type of single select, wherein a plurality of value added applications are associated with the stage, but only a single one of the plurality of value added applications is selected for processing by the flow processing service.

14. The method according to claim 11, wherein one of the plurality of stages has a stage type of multiple, wherein multiple value added applications are called one by one in order of definition.

15. A method, comprising:
creating a flow for execution by a flow processing service having a predefine application programming interface, wherein the flow comprises a plurality of stages and value added applications are assigned to at least one of the plurality of states,
wherein creating the flow comprises:
selecting a flow type for a stage,
configuring the plurality of stages,
wherein configuring of the stages is based on the flow type,
wherein a stage with flow type single are limited to one value added application,
wherein a stage with flow type single select is operable to select a single value added application for execution from a plurality of value added applications defined for that stage,
wherein a stage with flow type multiple calls multiple applications one by one by order of definition.
